(19) United States
(12) Patent Application Publication
(10) Pub. No.: US 2011/0297797 A1
(43) Pub. Date: Dec. 8, 2011

(54) ADJUSTABLE CABLE STOP

(76) Inventors: Forrest D. YELVERTON, Lyons, CO (US); William A. Baker, Louisville, CO (US)

(21) Appl. No.: 12/792,676

(22) Filed: Jun. 2, 2010

(51) Int. Cl. F16L 3/08; B23P 11/00

(52) U.S. Cl. 248/70; 248/65; 29/428

(57) ABSTRACT

A cable stop has a base member and an insert. The base member can be mounted to a frame member of an object such as a bicycle, and the insert can be inserted into the base member to accommodate various sizes, shapes and angular orientations required by particular cable systems. A method for mounting a cable stop to a frame member is also disclosed.

### BACKGROUND OF THE INVENTION

The present invention relates generally to cable stops for mechanical cable systems. Specifically, the present invention relates to an adjustable cable stop for cable systems commonly used with bicycles and other applications having similar characteristics and requirements.

Cable systems on bicycles are generally used in connection with the derailleur system to change gears and the brake system to activate and release the brakes. The cable systems include a series of cable stops that secure the cable to the bicycle, maintain appropriate tension, and direct the cable to the proper location.

In the bicycle manufacturing industry, it is common for a single bicycle frame design to be used in connection with many different commercial models. For example, the same bicycle frame design might be used for an economy model including the lowest cost components and a performance model including higher cost components. The economy model and the performance model might have different derailleur systems or different brake systems, which may require cables of different shapes and sizes or cable stops at different locations or orientations with respect to the bike frame. Cable stops are generally welded in place on the frame, and cannot be easily replaced, relocated or reoriented to accommodate the requirements of different components. Thus, different manufacturing and assembly set ups must be used for each model.

Accordingly, a need exists for an adjustable cable stop that will enable a multitude of different cable systems to be fitted to a standard frame. This invention relates to improvements to the devices described above, and to solutions to some of the problems raised or not solved thereby.

### SUMMARY OF THE INVENTION

The present invention provides a cable stop for use with a cable system. The present invention is particularly useful in connection with cable systems on a bicycle; however, the present invention could also be used with other types of cables systems with similar characteristics and requirements as will be apparent to those skilled in the art.

The cable stop of the present invention has a base member and an insert. The base member includes a mounting surface adapted to be mounted to a supporting member, and at least one wall defining an interior space. The insert is adapted for insertion into and removal from the interior space of the base member, and has an opening therethrough for accepting a cable from the cable system. In one embodiment, the opening is disposed at an offset angle from a centerline of the insert. In another embodiment, the opening is disposed in alignment with a centerline of the insert. The base member can include a slot to facilitate insertion and removal of the insert from the base member.

One embodiment of the present invention includes a base member, a mounting surface, a slot, at least one insert and an opening disposed through the at least one insert. The base member has an exterior and at least one wall defining an interior space. The interior space has at least one arcuate porton and at least one substantially flat portion. The mounting surface is disposed on the exterior of the base member, and the slot is disposed in the at least one wall of the base member. The insert includes an exterior with at least one arcuate portion and at least one substantially flat portion, wherein the exterior of the insert mates with the interior space of the base member. The opening is disposed at an angle at which a cable is intended to be oriented for a cable system. The insert can be inserted and removed from the base member, allowing the same base member to be used with multiple inserts designed for multiple cable systems having different cable angles, shapes and/or sizes. In one embodiment, the insert can be removed and replaced in an alternate orientation, such as rotated 180 degrees, from the original position.

The present invention also contemplates a method for mounting a cable stop to a frame member. The method includes the steps of: mounting a base member to the frame member at a selected location; determining the size, shape and angular orientation required for a cable at the selected location; selecting an insert having an opening of the required size, shape and angular orientation for the selected location; and inserting the insert into the base member.

Because the present invention allows the same base member to be used with multiple cable systems, many problems associated with the prior art are significantly improved or eliminated. For example, bicycle manufacturers can use a single bicycle frame for many different bicycle models without regard to the type of cable components that may be required for each model. The base members are standard, and can be adapted and adjusted for particular applications using the easily inserted and replaced inserts. Various other features, objects, and advantages of the invention will be apparent to those skilled in the art from the accompanying drawings and detailed description.

### BRIEF DESCRIPTION OF THE DRAWINGS

FIG. 1 is a perspective view of one embodiment of an adjustable cable stop of the present invention;

FIG. 2 is an exploded view of the cable stop of FIG. 1;

FIG. 3 is a rear, partial view of a bicycle frame, showing one embodiment of a cable stop of the present invention mounted on the frame and accommodating a cable at an offset angle therethrough;

FIG. 4 is a top view of one embodiment of a base member for a cable stop of the present invention;

FIG. 5 is a cross sectional view of the cable stop of FIG. 1, taken along plane 5-5 in FIG. 1;

FIG. 6 is a perspective view of the bicycle frame and cable assembly of FIG. 3;

FIG. 7 is a side view of the bicycle frame and cable assembly of FIG. 3;

FIG. 8 is a perspective view of the embodiment shown in FIG. 1, with the insert rotated 180 degrees;

FIG. 9 is a cross sectional view of the cable stop of FIG. 8, taken along plane 9-9 in FIG. 8; and

FIG. 10 is a cross-sectional view of the cable stop of FIG. 1, taken along plane 5-5 in FIG. 8, showing a cable and cable housing disposed therethrough.

### DETAILED DESCRIPTION OF THE PREFERRED EMBODIMENTS

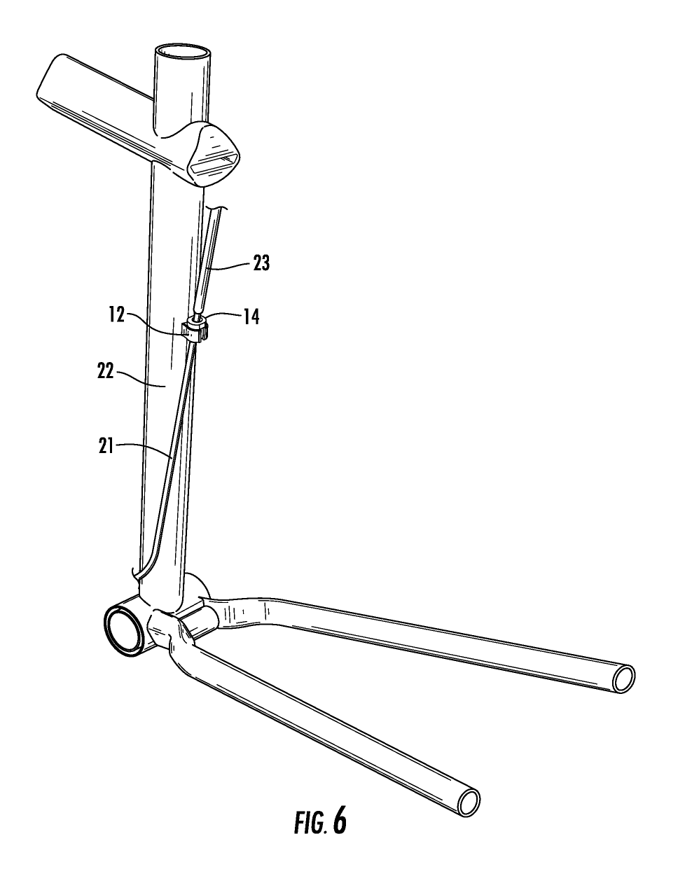

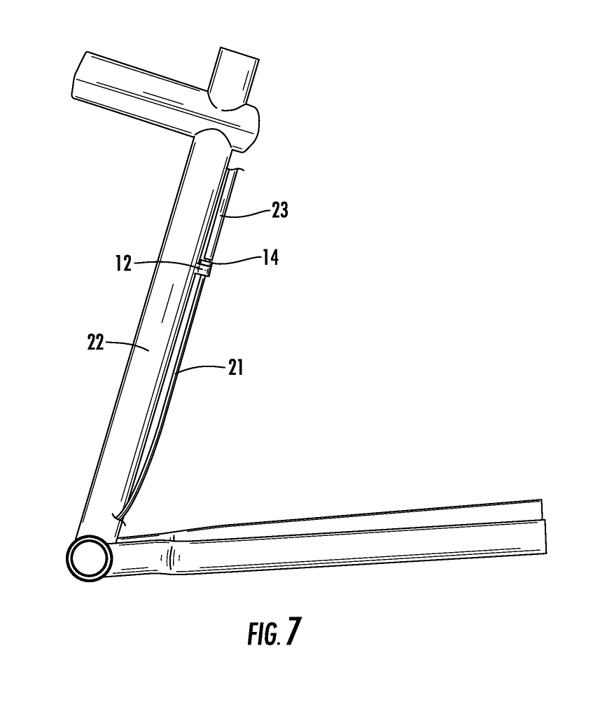

Referring now to the drawings, FIGS. 1-7 show one embodiment of an adjustable cable stop according to the present invention. The cable stop 10 includes a base member 12 and an insert 14. The base member 12 accepts the insert 14 therein and is adapted to be mounted to an object such as a bicycle frame. The insert 14 is adapted to accept a cable 21 and a cable housing 23. The cable 21 passes through the insert 14 and the cable housing 23 passes partially through the insert 14 as shown best in FIG. 10.

The base member 12 has a mounting surface 16, walls 18, and a slot 20. In the embodiment shown, the mounting surface 16 is opposite the slot 20 and the walls 18 have an arcuate shape. The mounting surface 16 can be shaped to accommodate the shape of the object to which the cable stop 10 is being mounted. For example, the mounting surface 16 shown has an arcuate curvature to match that of the bicycle frame member 22 to which the cable stop 10 is mounted in FIGS. 3, 6 and 7. In the embodiment shown, the walls 18 form an interior space 24 with arcuate side portions 26 and substantially flat front and rear portions 28, 30. The slot 20 is disposed through the front portion 28. The interior space 24 is open at the top and bottom thereof to accept the insert 14 and allow a cable 21 to pass therethough.

The insert 14 has a body 32 with an exterior shape corresponding to the shape of the interior space 24 of the base member. In the embodiment of FIGS. 1-7, the body 32 has arcuate side portions 34 and substantially flat front and rear portions 36, 38. Other corresponding or mating shapes could also be used. For example, a single flat portion 36 or 38 could be used. The insert 14 shown has a flange 40 disposed on a first end thereof and an opening 46 that extends through the insert 14. The opening 46 shown is a counter bore with a larger diameter at the top, to accept the diameter of the cable housing 23, and a smaller diameter at the bottom, to allow only the cable 21 to pass through the insert 14. The opening 46 is disposed through the insert 14 at an offset angle, as best shown in FIG. 4. The opening 46 of the insert 14 can be manufactured in different sizes and shapes to accommodate the varying sizes and shapes of cables that may be used with cable systems. The opening 46 can also be disposed at a number of angles to accommodate a wide variety of cable systems and location requirements. An offset of seven degrees from the centerline of the insert 14, for example, has been found to be particularly effective for certain derailleur systems for bicycles. The opening 46 could also be disposed at no offset, or at zero degrees from the centerline of the insert, when that arrangement is useful for a particular application.

When used on a bicycle frame, the base member 12 is mounted, preferably by welding but by any appropriate means, to the bicycle frame member 22. The body 32 of the insert 14 is inserted into the base member 12. The corresponding shapes of the interior space 24 of the base member 12 and the body 32 of the insert 14 facilitate ease of insertion and ensure that the opening 46 is in the correct orientation. The slot 20 in the base member 12 facilitates removal and re-insertion of the cable 21 from the base member 12 without having to disconnect the cable 21 from the derailleur or other device interacting with the cable system. The tension in the cable 21 can be loosened to allow the insert 14 to be pulled up and out of the base member 12, and the cable 21 can then pass through the slot 20 to be removed from the base member 12. The cable 21 can likewise be re-inserted into the base member 12 using the slot 20.

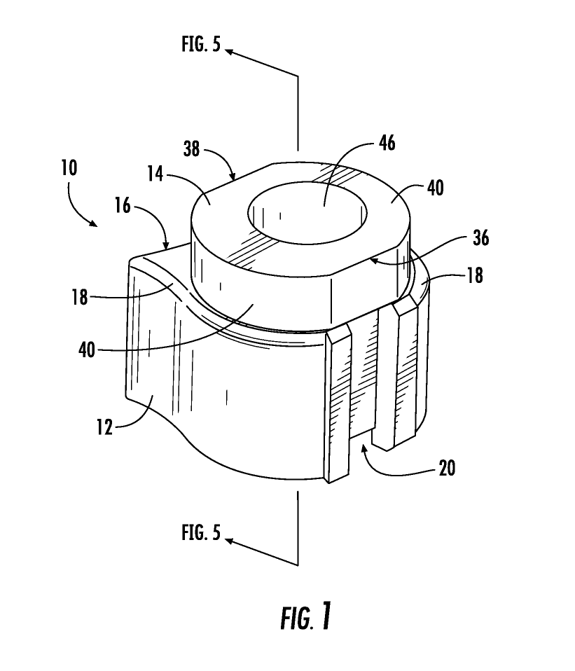

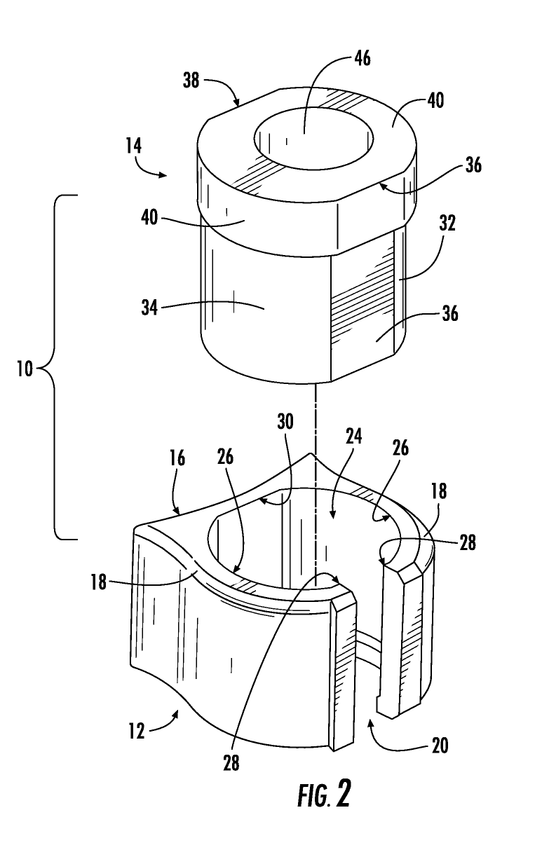

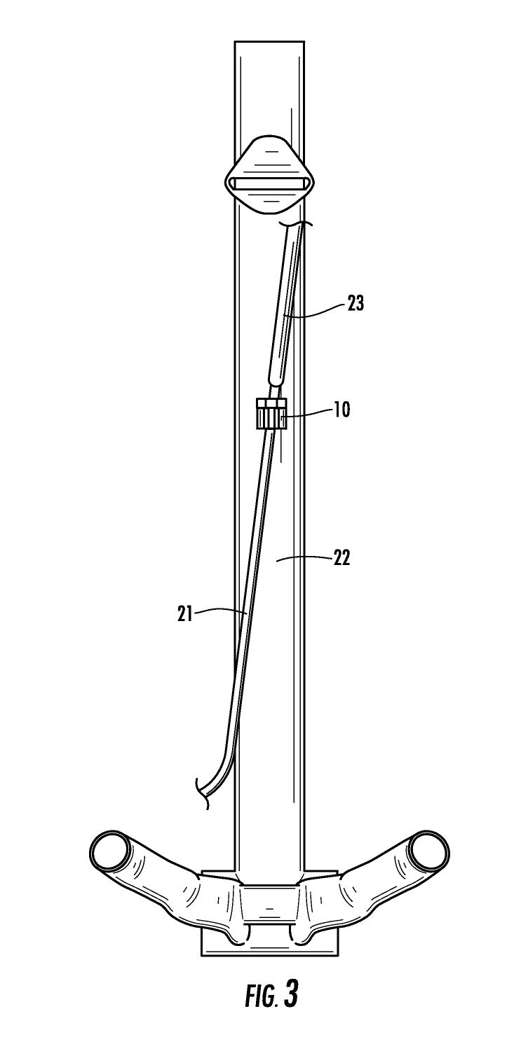

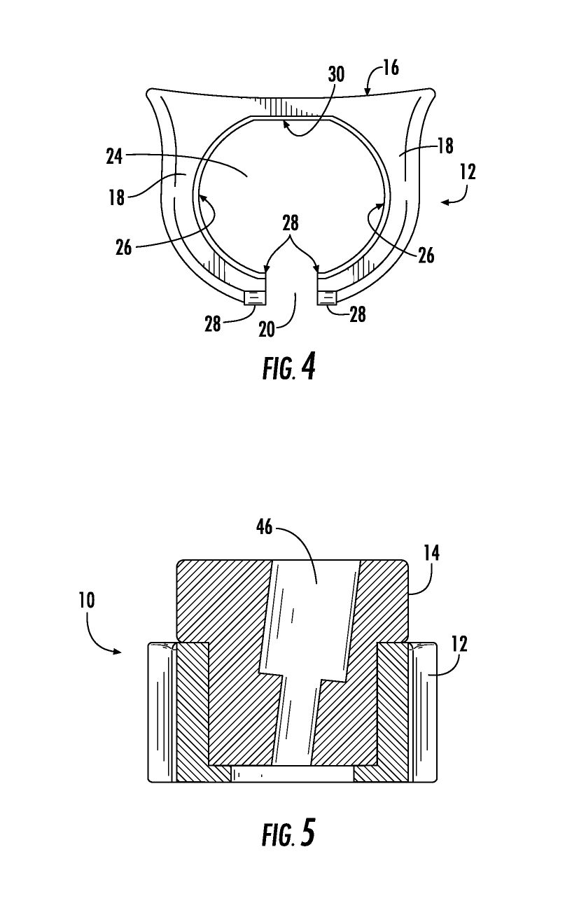

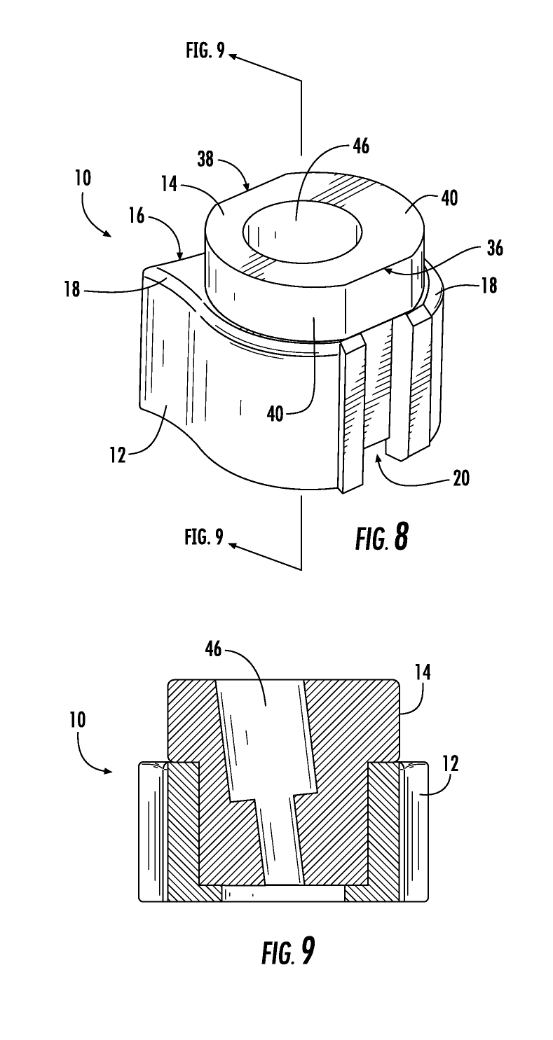

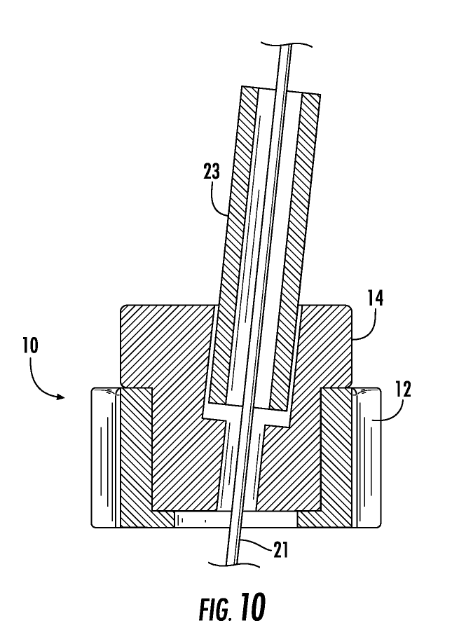

As shown in FIGS. 3, 6 and 7, the offset angle of the opening allows the cable to be oriented at the requisite angle for a particular cable system without reorienting the base member that is mounted to the bicycle frame member 22. Thus, the same base member 22 can be used with cable systems that require different cable orientations. To change the cable orientation, a different insert 14 with a different offset angle (or no offset angle, as the case may be) can be used. Alternatively, the same insert 14 can be used, but rotated in the base member 22. FIGS. 8 and 9 show the insert 14 of FIGS. 1 and 5 rotated 180 degrees in the base member 22 to achieve a different offset angle using the same parts. The use of both flat portions 28 and 30 on the interior space of the insert and corresponding flat portions 36 and 38 on the insert can be used to facilitate the 180 degree rotation option. Other mating shapes with 180 symmetry could also be used to facilitate that option. The same base member 22 can also be used with cable systems that require different sizes and shapes of cables, simply by using an insert 14 with an opening 46 corresponding to the size and shape needed for a particular cable system. Bicycle manufacturers can mount cable stop base members 12 to all of their bicycle frames, regardless of the cable systems that will later be used therewith.

It has been found particularly beneficial to manufacture the insert 14 from a plastic material using methods well known in the art, such as injection molding. Use of plastic material allows inserts with many different configurations to be easily and economically produced, however, other materials could also be used, such as but not limited to metallic, ceramic and fibrous materials. Likewise, the base member 22 is generally formed from a metal material suitable for welding to the bicycle frame, but other materials could also be used.

Although the invention has been herein shown and described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

I claim:

1. A cable stop for use with a cable system, the cable stop comprising:
a base member having a mounting surface and at least one wall defining an interior space, the mounting surface adapted to be mounted to a supporting member; and
an insert adapted for insertion into the interior space of the base member, the insert having an opening therethrough for accepting a cable from the cable system.

2. The cable stop of claim 1, wherein the opening is disposed at an offset angle from a centerline of the insert.

3. The cable stop of claim 1, wherein the opening is disposed in alignment with a centerline of the insert.

4. The cable stop of claim 1, wherein the base member includes at least one slot to facilitate removal of the cable from the base member.

5. The cable stop of claim 1, wherein the interior space of the base member and the insert have corresponding shapes.

6. The cable stop of claim 1, wherein the interior space of the base member and the insert are generally cylindrical in shape with corresponding substantially flat portions disposed on at least one side thereof.

7. The cable stop of claim 6, wherein the corresponding substantially flat portions are disposed on at least two sides thereof.

8. The cable stop of claim 1, wherein the interior space of the base member and the insert have corresponding shapes such that the insert can be inserted in a first orientation and a second orientation, wherein the second orientation is rotated 180 degrees from the first orientation.

9. The cable stop of claim 1, wherein the insert includes a flange at one end thereof.

10. The cable stop of claim 1, wherein the insert is formed from a plastic material.

11. The cable stop of claim 1, wherein the opening is sized and shaped to accommodate the cable for the cable system.

12. A cable stop assembly for use with a standard bicycle frame, the cable stop assembly comprising:
a base member having an exterior and at least one wall defining an interior space, the interior space having at least one arcuate portion and at least one substantially flat portion;
a mounting surface disposed on the exterior of the base member;
a slot disposed in the at least one wall of the base member;
at least one insert having an exterior with at least one arcuate portion and at least one substantially flat portion, wherein the exterior of the insert mates with the interior space of the base member;
an opening disposed through the at least one insert for accepting a cable for a cable system, the opening disposed at an angle at which the cable is intended to be oriented for the cable system; and
wherein the at least one insert can be inserted into the base member.

13. The cable stop assembly of claim 12, wherein the slot facilitates insertion and removal of the cable from the base member.

14. The cable stop assembly of claim 12, wherein the mounting portion is shaped to accommodate a frame element of a bicycle frame.

15. The cable stop assembly of claim 12, further comprising a plurality of inserts.

16. The cable stop assembly of claim 12, wherein the insert includes a flange at one end thereof.

17. The cable stop assembly of claim 12, wherein the insert can be inserted in a first orientation and a second orientation, wherein the second orientation is rotated 180 degrees from the first orientation.

18. The cable stop assembly of claim 12, wherein the exterior of the insert has at least two substantially flat portions and the interior space of the base member has at least two substantially flat portions.

19. A method of mounting a cable stop for a cable system, the method comprising the steps of:
mounting a base member to a frame member at a selected location;
determining the size, shape and angular orientation required for a cable at the selected location;
selecting an insert having an opening of the required size, shape and angular orientation for the selected location; and
inserting the insert into the base member.
